(19) United States
(12) Patent Application Publication
(10) Pub. No.: US 2022/0161250 A1
(43) Pub. Date: May 26, 2022

(54) CO-DEFLAGRATION SYNTHESIS OF METALLIC, CERAMIC, AND MIXED CERAMIC-METALLIC PARTICLES

(71) Applicant: Technology Innovation Momentum Fund (Israel) Limited Partnership, Tel Aviv (IL)

(72) Inventors: Brian Ashley ROSEN, Tel Aviv (IL); Michael GOZIN, Tel Aviv (IL); Eswara Vara Prasadarao KOMARALA, Tel Aviv (IL); Ludmila FADEEV, Tel Aviv (IL)

(21) Appl. No.: 17/594,037

(22) PCT Filed: Mar. 30, 2020
(86) PCT No.: PCT/IL2020/050383

§ 371 Date: Sep. 30, 2021

Related U.S. Application Data
(60) Provisional application No. 62/827,367, filed on Apr. 1, 2019.

(51) Int. Cl. B01J 37/08; B01J 23/10; B01J 23/44; B01J 23/745; B01J 23/755; B01J 23/83; B01J 21/10; B01J 37/02

(52) U.S. Cl. CPC B01J 37/088; B01J 23/10; B01J 23/44; B01J 37/0213; B01J 23/755; B01J 23/83; B01J 21/10; B01J 23/745

(57) ABSTRACT

A co-deflagration process for the preparation of metallic, ceramic, or mixed ceramic-metallic particles optionally impregnated within or attached to a metallic, ceramic, or mixed ceramic-metallic support material includes mixing at least two components. Each of the components can be any of a nitrogen-rich ligand or a salt thereof, a complex or coordination polymer of the nitrogen-rich ligand or salt thereof with one of the at least one metal, and a cluster of the at least one metal, and optionally an organic or inorganic oxidant, gas generator, pyrotechnic, propellant, and/or explosive.

### TECHNICAL FIELD

The present invention provides a co-deflagration process for the preparation of metallic, ceramic, or mixed ceramic-metallic particles optionally impregnated within or attached to a metallic, ceramic, or mixed ceramic-metallic support material.

Abbreviations: ATR, attenuated total reflection; BTA, bis(1H-tetrazole-5-yl)amine; DRM, dry reforming of methane; DSC, differential scanning calorimetry; FTIR, Fourier-transform infrared; RT, room temperature; SEM, scanning electron microscopy; TEM, transmission electron microscopy; TGA, thermographic analysis; XRD, X-ray diffraction (phase analysis).

### BACKGROUND ART

Co-deflagration process is a synthetic method for the production of multi-component ceramic, multi-component metallic, and mixed ceramic-metallic materials (cermets), which is based on the combustion of at least two metal-containing energetic complexes resulting in the release of gasses during combustion, as well as a solid-phase product. The co-deflagration process exploits the large energy transferred to metal atoms, metal ions and/or metal clusters during the combustion process in order to form well-mixed alloys and/or strongly bound particles of one phase (or phases) dispersed on and/or throughout a another phase (or phases).

Generating alloys of ceramic and/or metallic phases, or dispersing small particles of one phase within or about a larger particle of another phase, often requires high temperatures, and long heating/processing times, or multiple synthesis steps. The use of the co-deflagration process allows such phases to be synthesized rapidly, with lower (or minimal) external energy input (e.g., ignition based on heating, illuminating, or electric), since elevated temperatures are reached locally during the co-deflagration process (due to the combustion of the nitrogen-rich compounds). The size-distribution and surface area of the particles resulting from co-deflagration process can be tuned by changing the chemical nature of the nitrogen-rich component, and/or by the addition of other gas generators, pyrotechnics, propellants, explosives, fuels and/or oxidizers to the combustion mixture. Furthermore, combustible liquid mixtures containing nitrogen-rich metal-containing components dissolved or dispersed therein may enable the co-deflagration process to be operated continuously (as opposed to a batch process), by feeding the mixture through a heated orifice, making co-deflagration scalable and more economic.

The variety (structure, morphology and composition) of materials that could be made by using co-deflagration process is broader than that of traditional combustion synthesis, owing to the large amount of energy that is transferred to individual metal atoms, metal ions and/or metal clusters during the co-deflagration process.

WO 2018/229770 discloses the synthesis of a supported nanocatalyst prepared by the co-deflagration of a mixture of two high-nitrogen energetic metal complexes containing nickel and lanthanum, each in the form of a solid or semi-solid material.

### SUMMARY OF INVENTION

In one aspect, the present invention relates to a process for the preparation of particles optionally impregnated within or attached to a support material, said particles and said support material, when present, each independently comprising at least one metal or an oxide, carbide, carbonate, oxycarbonate, halide (such as chloride), oxyhalide (such as oxychloride), or alloy thereof, said process comprising:
(i) mixing at least two components each independently selected from a nitrogen-rich, optionally energetic nitrogen-rich, ligand or a salt thereof, a complex or coordination polymer of said nitrogen-rich ligand or salt thereof with one of said at least one metal, or a cluster of said at least one metal, and optionally an organic or inorganic oxidant, gas generator, pyrotechnic, propellant and/or explosive, wherein each one of said at least two components independently is in the form of a solid, semi-solid, or ionic liquid, and at least one of said components is a metal complex or coordination polymer of said nitrogen-rich ligand or salt thereof, or a metal cluster, to thereby obtain a homogeneous solid, semi-solid, or ionic liquid material;
(ii) optionally grinding said homogeneous solid material;
(iii) optionally pressing said homogeneous solid or semi-solid material into a form (pellet); and
(iv) heating or igniting said ionic liquid material or optionally pressed homogeneous solid or semi-solid material, at a temperature sufficient to combust said at least two components, but not exceeding 600° C., to thereby obtain said particles, optionally impregnated within or attached to said support material,

provided that when (1) two or more of said at least two components each is a metal complex, metal coordination polymer, or metal cluster, and one of said at least one metal is a lanthanide; and (2) the material obtained in step (i) upon mixing said at least two components is not an ionic liquid material, the amount, by moles, of the lanthanide is lower than the total amount, by moles, of the other metal(s).

In certain embodiments, the process of the present invention is for the preparation of particles comprising a lanthanide or an oxide, carbide, carbonate, oxycarbonate, halide (such as chloride), oxyhalide (such as oxychloride), or alloy thereof, optionally impregnated within or attached to a support material comprising at least one metal, or an oxide, carbide, carbonate, oxycarbonate, halide (such as chloride), oxyhalide (such as oxychloride), or alloy thereof,

wherein one of said at least two components mixed in step (i) is selected from a complex or coordination polymer of said lanthanide and a nitrogen-rich ligand or a salt thereof, or a cluster of said lanthanide; and the other(s) of said at least two components each independently is selected from a nitrogen-rich ligand or a salt thereof, a complex or coordination polymer of said nitrogen-rich ligand of salt thereof with one of said at least one metal, or a cluster of said at least one metal, wherein each one of said at least two components is in the form of a solid, or semi-solid,

provided that when at least one of said components is a complex, coordination polymer, or cluster of a metal other than said lanthanide, the amount, by moles, of said organic or inorganic oxidant, gas generator, pyrotechnic, propellant and/or explosive is higher than the total amount, by moles, of said lanthanide and said at least one metal.

In a particular such aspect, the invention relates to a process for the preparation of particles optionally impregnated within or attached to a support material, each as defined above, wherein at least one of the components mixed in step (i) is in the form of an ionic liquid, e.g., a nitrogen-rich ligand or a salt thereof in the form of an energetic ionic liquid, and the material obtained in step (i) upon mixing said components is an ionic liquid material, which is then heated or ignited according to step (iv). Non-limiting examples of such energetic ionic liquids include 1-amino-3-alkyl-1,2,3-triazolium nitrate, 4-amino-1-alkyl-1,2,4-triazolium nitrate, and 1-alkyl-3-alkyl-imidazolium nitrate,

The process of the present invention may be carried out, e.g., in a suitable reactor such as a flame reactor, as either a batch process or a continuous process.

A product prepared (obtained) by a process as disclosed herein, consisting of particles optionally impregnated within or attached to a support material, each as defined above, is herein also referred to as “a metallic product”. Such metallic products may be used, e.g., as catalysts in various chemical processes such as dry or steam reforming of a hydrocarbon (e.g., methane); carbon monoxide oxidation; carbon dioxide hydrogenation; hydrocarbon dehydrogenation; NOₓ abatement; gas-to-liquid (GTL) processing; hydrothermal liquefaction; and water purification. The metallic products may further be used as piezoelectrics; thermoelectrics; dielectrics, or dielectric materials; ferroelectrics; pyroelectrics; or thermal barrier, as well as in glass (optics) manufacturing.

In another aspect, the present invention provides a metal-N,N-bis(1H-tetrazole-5-yl)-amine (M-BTA) complex, wherein said metal (M) is Ce, Rh, Ru, Pd, Os, or Ir.

### BRIEF DESCRIPTION OF DRAWINGS

FIG. 1 shows TGA and DSC of the deflagration of the Pd-BTA complex.

FIG. 2 shows XRD pattern of the particles resulting from the co-deflagration of a mixture of Ce-BTA, Mn-BTA and ammonium nitrate.

FIG. 3 shows SEM image of micro-sized particles produced by the co-deflagration of a mixture of Ce-BTA, Mn-BTA and ammonium nitrate.

FIG. 4 shows SEM image and elemental mapping showing the even distribution of Mn, Ce, and O throughout the alloy particles produced by the co-deflagration of a mixture of Ce-BTA, Mn-BTA and ammonium nitrate.

FIG. 5 shows TEM images showing that the CeO₂—MnO₂ alloy material generated by the co-deflagration of a of mixture of Ce-BTA, Mn-BTA and ammonium nitrate has nano-sized domains on the scale of 10 nm.

FIG. 6 shows SEM image and elemental mapping showing the even distribution of Pd, La, C, and O throughout the alloy particles produced by the co-deflagration of a mixture of Pd-BTA, La-BTA and ammonium nitrate.

FIG. 7 shows XRD pattern of Pd+PdO supported on or about La₂O₂CO₃.

FIGS. 8A-8B show TEM and accompanying XRD pattern showing nanosized LaFeO₃ particle on La₂O₃ support via the co-deflagration of La-BTA and Fe-BTA.

FIG. 9 shows atomic mapping (energy dispersive x-ray spectroscopy) of Ni—Fe alloy particles in the SEM.

FIG. 10 shows SEM image of porous spherical Ni particle generated by co-deflagration.

### DETAILED DESCRIPTION

Nitrogen-rich energetic materials could be used as gas generators, pyrotechniques, propellants and/or explosives, as they are able to release gas products at subsonic speeds upon their combustion, i.e., deflagration or detonation. Such materials are mostly transformed into various gasses, such as N₂, CO₂, CO, NOₓ, H₂O, and NH₃. When such nitrogen-rich materials form a compound or mixture with a metal atom (in the form of a molecule, a salt, a complex, a metal cluster, a metal-organic framework, a coordination polymer, etc.), a large amount of thermal and kinetic energy is imparted onto the metal atom and/or metal ion upon combustion and/or detonation, and solid particles are formed.

Upon exposure to such high energy, metal atoms, metal ions, metal containing fragments and metal clusters can collide with each other and condense to form nanometer-, micron-, and/or millimeter-sized particles. The combustion of nitrogen-rich metal-containing compounds and materials can therefore generate metal-containing particles.

When multiple nitrogen-rich compounds and materials (at least one of which containing a metal) are simultaneously ignited, a wide variety of multi-phase materials, in the form of sub-mm and sub-micrometer particles, can be rapidly formed. In addition to metal particles, oxygen from, e.g., the atmosphere, as well as CO and CO₂ generated by the ignition, can be incorporated into the particle, thereby allowing the formation of metal oxides, metal carbides, metal carbonates and/or metal oxycarbonates. Halide atoms present in the nitrogen-rich metal-containing compound can also be incorporated into the generated particles in the form of metal halide, e.g., metal chloride, or metal oxyhalides, e.g., metal oxychorides. The size, structure, and orientation of the crystalized particles with respect to one another are determined by: (i) the nature of the nitrogen-rich compound; (ii) the rate of heat release; (iii) the ability of the metal to form oxides, carbides, carbonates, oxycarbonates, or oxychlorides; (iv) the concentration-ratio between the metals; and (v) the nature of a third component (e.g., an oxidant, gas generator, propellant, pyrotechnic, and/or explosive) that may optionally be added to the combustion mixture.

It has now been found in accordance with the present invention that the variety (structure, morphology and composition) of materials that could be made by using co-deflagration process may be broader than that of traditional combustion synthesis, owing to the large amount of energy that is transferred to individual metal atoms, metal ions and/or metal clusters during the co-deflagration process.

In one aspect, the present invention relates to a process for the preparation of particles optionally impregnated within or attached to a support material, said particles and said support material, when present, each independently comprising at least one metal or an oxide, carbide, carbonate, oxycarbonate, halide, oxyhalide, or alloy thereof, said process comprising:
(i) mixing at least two components each independently selected from a nitrogen-rich, optionally energetic nitrogen-rich, ligand or a salt thereof, a complex or coordination polymer of said nitrogen-rich ligand or salt thereof with one of said at least one metal, or a cluster of said at least one metal, and optionally an organic or inorganic oxidant, gas generator, pyrotechnic, propellant and/or explosive, wherein each one of said at least two components is in the form of a solid, semi-solid, or ionic liquid, and at least one of said components is a metal complex or coordination polymer of said nitrogen-rich ligand or salt thereof, or a metal cluster, to thereby obtain a homogeneous solid, semi-solid, or ionic liquid material;
(ii) optionally grinding said homogeneous solid material;
(iii) optionally pressing said homogeneous solid or semi-solid material into a form (pellet); and
(iv) heating or igniting said ionic liquid material or optionally pressed homogeneous solid or semi-solid material, at a temperature sufficient to combust said at least two components, but not exceeding 600° C., to thereby obtain said particles, optionally impregnated within or attached to said support material,

provided that when (1) two or more of said components each is a metal complex, metal coordination polymer, or metal cluster, and one of said at least one metal is a lanthanide; and (2) the material obtained in step (i) upon mixing said at least two components is not an ionic liquid material, the amount, by moles, of the lanthanide is lower than the total amount, by moles, of the other metal(s).

The metallic product prepared by the process disclosed herein is in the form of particles, e.g., millimeter-sized particles, microparticles, or nanoparticles, comprising at least one metal or an oxide, carbide, carbonate, oxycarbonate, halide (e.g., chloride), oxyhalide (e.g., oxychloride), or alloy thereof, wherein said particles are optionally impregnated within or attached to a support material that comprises at least one same or different metal or an oxide, carbide, carbonate, oxycarbonate, halide (e.g., chloride), oxyhalide (e.g., oxychloride), or alloy thereof. Said support material, when present, is therefore decorated, rather than completely coated or covered, by said particles. The distribution of the particles decorating the support material may vary depending on the various conditions of the combustion synthesis and post-combustion treatment, used for the preparation of the product, and in certain cases said particles are uniformly, or in fact relatively uniformly, distributed over the support material.

The term “impregnated” as used herein with respect to the particles prepared by the process of the invention means that said particles are not only attached to the support material but could be, partially or completely, imbedded within said support material, as a result of the combustion process used for the preparation of the particular product.

According to the process disclosed herein, the at least two components mixed in step (i) each independently is a nitrogen-rich ligand, e.g., an energetic nitrogen-rich ligand, or a salt thereof; a complex or coordination polymer of said nitrogen-rich ligand or salt thereof with one of said at least one metal (herein also referred to as “metal complex” or “metal coordination polymer”, respectively); or a cluster of said at least one metal (herein also referred to as “metal cluster”). In certain particular embodiments, at least two of said at least two components each independently is a complex, coordination polymer, or cluster of a different metal, and the product thus obtained comprises two or more metals, optionally in the form of their oxides, carbides, carbonates, oxycarbonates, halides, or oxyhalides, and/or an alloy of said two or more metals. In other particular embodiments, two of said at least two components each independently is a complex, coordination polymer, or cluster of the same metal, and the product thus obtained comprises a sole metal, optionally partially or completely in the form of its oxides, carbides, carbonates, oxycarbonates, halides, or oxyhalides. In further particular embodiments, only one of said at least two components is a metal complex, metal coordination polymer, or metal cluster, and the product thus obtained comprises a sole metal, optionally partially or completely in the form of its oxides, carbides, carbonates, oxycarbonates, halides, or oxyhalides. It should be understood that in any one of these embodiments, additional one or more nitrogen-rich ligands may be used in the process as an energy source.

According to the present invention, in case (1) two or more of the components mixed in step (i) each is a complex, coordination polymer, or cluster of a different metal, and one of said metals is a lanthanide; and (2) the material obtained in step (i) upon mixing said at least two components is not an ionic liquid material (i.e., each one independently of the components mixed is in the form of a solid or semi-solid), the amount, by moles, of the lanthanide is lower than the total amount, by moles, of the other metal(s), i.e., lower than 50% of the overall amount of metals. Under these conditions, a lanthanide-containing product obtained by the process of the present invention will include said lanthanide, optionally partially or completely in the form of its oxides, carbides, carbonates, oxycarbonates, halides, or oxyhalides, in the particles only, i.e., not in the support material.

The term “lanthanide” as used herein refers to any one of the series of fifteen metallic elements from lanthanum to lutetium in the Periodic Table, also known as “rare earth elements”, i.e., lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). In particular embodiments, the lanthanide used in the process of the invention is La, Ce, Pr, Nd, Pm, Sm, or Gd, but preferably La.

Post treatment of co-deflagration-generated particles (solid residue) may include (i) oxidation, for formation of oxides and cleaning; (ii) reduction, for transforming metal oxides into metals; (iii) carburization, for transforming metal oxides and metals into their carbides or oxycarbides; (iv) nitridization, for transforming metal oxides into nitrides or oxynitrides; and/or (v) sulfurization, for transforming metal oxides into sulfides or oxy sulfides.

In certain embodiments, the process of the present invention thus further comprises the steps of: (v) subjecting the particles obtained in step (iv) to a temperature sufficient to oxidize residual organic matter, but not exceeding 1200° C., in the flow of a mixture comprising O₂, O₃, a nitrogen oxide, an organic peroxide, or hydrogen peroxide, and an inert gas selected from Ar, He or N₂; and/or (vi) subjecting the product obtained in step (v) to a temperature sufficient to reduce the oxide of said metal or metal alloy obtained, but not exceeding 1200° C., in the flow of a mixture comprising an inert gas selected from Ar, He or N₂, and a reducing gas such as H₂ or NH₃.

In order to transform metal oxides and metals generated by the process of the present invention into their carbides or oxycarbides, the product obtained in step (v) may be subjected, i.e., exposed, to methane, at a temperature sufficient to transform the metals or metal oxides obtained into their carbide or oxycarbide forms (i.e., at a temperature above about 700° C. for at least 1 hour, and typically about 800° C. for about 2 hours). Alternatively, the product obtained in step (v) may be mixed with solid carbon particles to form a mixture, which is then treated with hydrogen gas at a temperature above about 700° C. for 1 hour (typically about 800° C. for 2 hours).

In order to transform metal oxides and metals generated by the process of the present invention into their nitrides or oxynitrides, the product obtained in step (v) may be exposed to ammonia, at a temperature sufficient to transform the metals or metal oxides obtained into their nitride or oxynitride forms (i.e., at a temperature above about 500° C. for at least 5 hour, and typically about 900° C. for about 48 hours).

In order to transform metal oxides and metals generated by the process of the present invention into their sulfides or oxysulfides, the product obtained in step (v) may be exposed to sulfur, at a temperature sufficient to transform the metals or metal oxides obtained into their sulfide or oxysulfide forms (i.e., at a temperature above about 500° C. for at least 1 hour, and typically about 600° C.-700° C. for about 1-4 hours).

The types of materials that could be generated by post-treatment of co-deflagration-generated particles include (i) ceramic particles supported on ceramic (as the support material); (ii) ceramic particles supported on ceramic alloys (as the support material); (iii) ceramic alloys (as particles; no support material); (iv) metal and metal alloy particles supported on ceramic materials (as the support material); (v) metal and metal alloy particles supported on ceramic alloys (as the support material); (vi) cermets (particles; no support material); and (vii) metal and metal alloys (particles; no support material).

In certain embodiments, at least one of the components mixed in step (i) of the process disclosed herein is a metal complex of said nitrogen-rich ligand or a salt thereof, wherein said metal complex is in the form of a metal organic framework, i.e., a compound consisting of metal ions or clusters coordinated to said nitrogen-rich ligand to form one-, two-, or three-dimensional structures, or a coordination polymer, i.e., an inorganic- or organometallic polymer structure containing metal cation centers linked by said nitrogen-rich ligand.

As stated above, the product prepared by the process of the present invention comprises particles and optionally a support material, each independently comprising at least one metal or an oxide, carbide, carbonate, oxycarbonate, halide, oxyhalide, or alloy thereof. In certain embodiments, said at least one metal each independently is selected from (i) lithium (Li), sodium (Na), potassium (K), rubidium (Rb), caesium (Cs); (ii) beryllium (Be), magnesium (Mg), calcium (Ca), strontium (Sr), barium (Ba); (iii) scandium (Sc), yttrium (Y); (iv) lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu); (v) titanium (Ti), zirconium (Zr), hafnium (Hf); (vi) vanadium (V), niobium (Nb), tantalum (Ta); (vii) chromium (Cr), molybdenum (Mo), tungsten (W); (viii) manganese (Mn), rhenium (Re); (ix) iron (Fe), ruthenium (Ru), osmium (Os); (x) cobalt (Co), rhodium (Rh), iridium (Ir); (xi) nickel (Ni), palladium (Pd), platinum (Pt); (xii) copper (Cu), silver (Ag), gold (Au); (xiii) zinc (Zn), cadmium (Cd); (xiv) aluminium (Al), gallium (Ga), indium (In); (xv) silicon (Si), germanium (Ge), tin (Sn), plumbum (Pb); (xvi) antimony (Sb), bismuth (Bi); or (xvii) selenium (Se), or tellurium (Te). In particular embodiments, said at least one metal each independently is La, Ce, Mn, Fe, Ni, Rh, Ru, Pd, Os, or Ir.

In certain embodiments, one of said at least one metal is Ce and the other one of said at least one metal is Mn, i.e., one of the components mixed in step (i) of the process is a Ce complex or coordination polymer of a nitrogen-rich ligand or a salt thereof, or a Ce cluster; and another one of the components is a Mn complex or coordination polymer of a nitrogen-rich ligand or a salt thereof, or a Mn cluster. In other embodiments, one of said at least one metal is Pd and the other one of said at least one metal is La, i.e., one of the components mixed in step (i) of the process is a Pd complex or coordination polymer of a nitrogen-rich ligand or a salt thereof, or a Pd cluster; and another one of the components is a La complex or coordination polymer of a nitrogen-rich ligand or a salt thereof, or a La cluster (wherein the amount, in moles, of the La is lower than the amount of the Pd). In still other embodiments, one of said at least one metal is La and the other one of said at least one metal is Fe, i.e., one of the components mixed in step (i) of the process is a La complex or coordination polymer of a nitrogen-rich ligand or a salt thereof, or a La cluster; and another one of the components is a Fe complex or coordination polymer of a nitrogen-rich ligand or a salt thereof, or a Fe cluster (wherein the amount, in moles, of the La is lower than the amount of the Fe). In yet other embodiments, one of said at least one metal is Ni and the other one of said at least one metal is Fe, i.e., one of the components mixed in step (i) of the process is a Ni complex or coordination polymer of a nitrogen-rich ligand or a salt thereof, or a Ni cluster; and another one of the components is a Fe complex or coordination polymer of a nitrogen-rich ligand or a salt thereof, or a Fe cluster. In further embodiments, said particles comprise a sole metal, or an oxide, carbide, carbonate, oxycarbonate, halide, or oxyhalide, thereof, i.e., only one of the components mixed in step (i) is a metal complex or coordination polymer of a nitrogen-rich ligand or a salt thereof, or a cluster of said metal; or more than one of said components each independently is a complex, coordination polymer, or cluster, as defined hereinabove, of the same metal. In particular such embodiments, said component is a Ni complex or coordination polymer of a nitrogen-rich ligand or a salt thereof, or a Ni cluster, and the particles thus obtained comprises Ni, or an oxide, carbide, carbonate, oxycarbonate, halide, or oxyhalide thereof.

The term “nitrogen-rich ligand” as used herein denotes a nitrogen-rich cyclic and/or non-cyclic anion, cation, charged and/or non-charged ligand, i.e., a compound and/or material having nitrogen-to-carbon atomic ratio ≥1 or containing no carbon atoms at all.

In certain embodiments, the nitrogen-rich ligand or salt thereof used according to the process of the present invention each independently is selected from the group consisting of ammonia, amides, hydroxylamine, nitroso, nitrate, nitrite, azide, hydrazine, imidazoles, aminoimidazoles, hydrazoimidazoles, nitroimidazoles, azidoimidazoles, triazoles, aminotriazoles, hydrazotriazoles, cyanotriazoles, nitrotriazoles, azidotriazoles, tetrazoles, N,N-bis(1H-tetrazole-5-yl)-amine (BTA), aminotetrazoles, hydrazotetrazoles, cyanotetrazoles, nitrotetrazoles, azidotetrazines, pentazoles, triazines, aminotriazines, melamine, 2,4,6-trihydrazineyl-1,3,5-triazine, hydrazotriazines, cyanotriazines, nitrotriazines, tetrazines, aminotetrazines, 3,6-di amino-1,2,4,5-tetrazine-1,4-dioxide, hydrazotetrazines, cyanotetrazines, ureas, hydrazinecarboxamides, nitroureas, cyanoureas, oxalohydrazides, 2-amino-2-iminoacetamide, oxalimidamide, 2-hydrazineyl-2-iminoacetohydrazide, oxalimidohydrazide, guanidines, guanylureas, aminoguanidines, cyanoguanidines, nitroguanidines, dinitromethanes, trinitromethanes, N-nitro-nitramide, N-nitrocyanamide, N-dicyanamide, a mixture of ammonium nitrate with hydrazine (Astrolite G), hydrazinium nitrate, hydroxylammonium nitrate, and an energetic ionic liquid.

The term “energetic ionic liquid” as used herein refers to an energetic nitrogen-rich ionic (salt) materials, that is stable in its liquid (melted) form at temperature below its decomposition temperature. Examples of energetic ionic liquid compounds reported in the literature include 1-amino-3-alkyl-1,2,3-triazolium nitrates, 4-amino-1-alkyl-1,2,4-triazolium nitrate, and 1-alkyl-3-alkyl-imidazolium nitrate, some of which have melting points (in a pure form) below 35° C., that could be further lowered upon mixing with, e.g., lanthanides-containing materials (for further examples, see Zhang and Shreeve, 2014; Sebastiao et al., 2014; Drake et al., 2007; Prodius and Mudring, 2018; Ji et al., 2013; Tao et al., 2008; and Binnemans, 2007);

The term “alkyl” as used herein typically means a linear or branched hydrocarbon radical having, e.g., 1-18 carbon atoms and includes methyl, ethyl, n-propyl, isopropyl, n-butyl, sec-butyl, isobutyl, tert-butyl, n-pentyl, 2,2-dimethylpropyl, n-hexyl, n-heptyl, n-octyl, and the like

In particular such embodiments, said nitrogen-rich ligand or salt thereof each independently is triazole, tetrazole, BTA, 5,5-diazotetrazolate triazole, tetrazine, melamine, a nitramine, a guanidine, a guanylurea, a nitroguanidine, a nitrourea, an aminoguanidine, or an energetic ionic liquid selected from the group consisting of 1-amino-3-alkyl-1,2,3-triazolium nitrate, 4-amino-1-alkyl-1,2,4-triazolium nitrate, and 1-alkyl-3-alkyl-imidazolium nitrate. In more particular such embodiments, said nitrogen-rich ligand or salt thereof each independently is the energetic nitrogen-rich ligand BTA, or an energetic ionic liquid selected from the group consisting of 1-amino-3-ethyl-1,2,3-triazolium nitrate, 1-amino-3-propyl-1,2,3-triazolium nitrate, 1-amino-3-(2-propenyl)-1,2,3-triazolium nitrate, 4-amino-1-methyl-1,2,4-triazolium nitrate, 4-amino-1-ethyl-1,2,4-triazolium nitrate, 4-amino-1-butyl-1,2,4-triazolium nitrate, 1-butyl-3-methyl-imidazolium nitrate, 1-isobutyl-3-methyl-imidazolium nitrate, and 1-dodecyl-3-methyl-imidazolium nitrate.

In certain embodiments, at least one of the at least two components mixed in step (i) each independently is: (a) a complex of BTA with a metal selected from the group consisting of La, Ce, Mn, Fe, Ni, Rh, Ru, Pd, Os, and Ir, i.e., La-BTA, Ce-BTA, Mn-BTA, Fe-BTA, Ni-BTA, Rh-BTA, Ru-BTA, Pd-BTA, Os-BTA, or Ir-BTA; (b) an energetic ionic liquid selected from the group consisting of 1-amino-3-ethyl-1,2,3-triazolium nitrate, 1-amino-3-propyl-1,2,3-triazolium nitrate, 1-amino-3-(2-propenyl)-1,2,3-triazolium nitrate, 4-amino-1-methyl-1,2,4-triazolium nitrate, 4-amino-1-ethyl-1,2,4-triazolium nitrate, 4-amino-1-butyl-1,2,4-triazolium nitrate, 1-butyl-3-methyl-imidazolium nitrate, 1-isobutyl-3-methyl-imidazolium nitrate, and 1-dodecyl-3-methyl-imidazolium nitrate; or (c) a lanthanate-containing energetic ionic liquid selected from the group consisting of [1-amino-3-ethyl-1,2,3-triazolium]₃ [La(NO₃)₆], [1-amino-3-propyl-1,2,3-triazolium]₃[La(NO₃)₆], [1-amino-3-(2-propenyl)-1,2,3-triazolium]₃[La(NO₃)₆], [4-amino-1-methyl-1,2,4-triazolium]₃[La(NO₃)₆], [4-amino-1-ethyl-1,2,4-triazolium]₃[La(NO₃)₆], [4-amino-1-butyl-1,2,4-triazolium]₃[La(NO₃)₆], [1-butyl-3-methyl-imidazolium]₃[La(NO₃)₆], [1-isobutyl-3-methyl-imidazolium]₃[La(NO₃)₆], and [1-dodecyl-3-methyl-imidazolium]₃[La(NO₃)₆].

In certain embodiments, the at least two components are mixed in step (i) with an organic or inorganic oxidant, gas generator, pyrotechnic, propellant, or explosives. Particular such embodiments are those wherein only solid or semi-solid components are used. Suitable inorganic oxidants for use in the process of the present invention include, without being limited to, ammonium nitrate, ammonium dinitramide, and ammonium perchlorate; and non-limiting examples of organic oxidants include a peroxide, a trinitromethane salt, 2,2,2-trinitroethanol or a derivative thereof, 2,2-dinitromethane or a salt or derivative thereof, or 2,2-dinitroethanol or a salt or derivative thereof.

In certain embodiments, the homogeneous ionic liquid material or optionally pressed homogeneous solid or semi-solid material is heated or ignited in step (iv) together with one or more combustible additives such as alcohols (e.g., methanol, ethanol, iso-propanol, heptanol and dodecanol), ethers (e.g., methyl-tert-butyl ether, dibutyl ether, tetrahydrofuran, and dioxane), esters (e.g., ethyl acetate, butyl propionate, hexyl valerate, and delta-valerolactone), aldehydes (e.g., butylaldehyde, hexylaldehyde, and dodecylaldehyde), ketones (e.g., acetone, ethylmethyl ketone, and cyclohexyl ketone), nitriles (e.g., acetonitrile and butyronitrile), nitroalkanes (e.g., nitromethane and nitropropane), amines (e.g., hexylamine, dibutyl-amine, and triethyl-amine) and amides (e.g., formamide, dimethylformamide, and gamma-butyrolactame). According to the present invention, any combustible additive or a combination thereof may be used provided that once added to the homogeneous material obtained in step (i), i.e., said ionic liquid material, or solid or semi-solid material, it does not increase the melting point of said homogeneous material, and does not alter the viscosity thereof.

According to the present invention, once the homogeneous ionic liquid material or optionally pressed homogeneous solid or semi-solid material is heated or ignited in step (iv), said material is combusted at a combustion temperature that might be equal, higher, or lower than the ignition temperature of said material, until the desired metallic product is obtained.

In certain embodiments, the particles obtained in step (iv) of the process disclosed herein, which are optionally impregnated within or attached to said support material, when present, are made of a metal, metal alloy, ceramic, ceramic alloy, or a combination thereof; and the support material, when obtained, is made of a ceramic, ceramic alloy, or a combination thereof.

In certain particular embodiments, (a) the components mixed in step (i) of the process disclosed herein are a Ce-BTA complex and a Mn-BTA complex, said inorganic oxidant is ammonium nitrate, the molar ratio between said Ce-BTA complex, said Mn-BTA complex and said ammonium nitrate is about 1:1:4, respectively, said temperature sufficient to combust said components is about 350° C., and the particles obtained in step (iv) are metallic Mn particles impregnated within or attached to a ceramic alloy support material made of CeO₂ and MnO₂; (b) the components mixed in step (i) of the process are a Ni-BTA complex and a Fe-BTA complex, said inorganic oxidant is ammonium nitrate, the molar ratio between said Ni-BTA complex, said Fe-BTA complex and said ammonium nitrate is about 5:1:4, respectively, said temperature sufficient to combust said components is about 340° C., and the particles obtained in step (iv) are unsupported metal alloy Ni—Fe particles; (c) the components mixed in step (i) of the process are a Ni-BTA complex and BTA, said temperature sufficient to combust said components is about 320° C., and the particles obtained in step (iv) are metallic Ni particles; (d) the components mixed in step (i) are [4-amino-1-methyl-1,2,4-triazolium]₃ [La (NO₃)₆], Ni-BTA complex and [4-amino-1-methyl-1,2,4-triazolium][NO₃], at a weight ratio of about 33:16:100, respectively, forming an ionic liquid mixture; acetonitrile is optionally added to regulate the viscosity of said ionic liquid; air is optionally added as an oxidizing gas; the ionic liquid mixture is combusted at a temperature in a range from about 300° C. to about 1200° C.; and the particles obtained in step (iv) are unsupported ceramic particles containing nickel oxide and lanthanum oxide; or (e) the components mixed in step (i) are [1,5-diamino-4-methyl-1,2,3,4-tetrazolium]₃[Ce(NO₃)₆], Mn-BTA complex and [4-amino-1-methyl-1,2,4-triazolium][NO₃], at a weight ratio of about 35:19.5:150, respectively, forming an ionic liquid mixture; ethylammonium nitrate is optionally added to regulate the viscosity of said ionic liquid; nitrous oxide is optionally added as an oxidizing gas; the ionic liquid mixture is combusted at a temperature in a range from about 300° C. to about 1200° C.; and the particles obtained in step (iv) are unsupported ceramic particles containing manganese oxide and cerium oxide.

In certain embodiments, the process of the present invention, as defined in any one of the embodiments above, is for the preparation of (i) a ceramic particles impregnated within or attached to a ceramic as the support material; (ii) a ceramic particles impregnated within or attached to a ceramic alloy as the support material; (iii) a ceramic alloy particles; (iv) a metal or metal alloy particles supported on a ceramic as the support material; (v) a metal or metal alloy particles supported on a ceramic alloy as the support material; (vi) a cermet particles; or (vii) a metal or metal alloy particles.

In certain embodiments, the process of the present invention, as defined in any one of the embodiments above, is for the preparation of particles comprising a lanthanide or an oxide, carbide, carbonate, oxycarbonate, halide, oxyhalide, or alloy thereof, optionally impregnated within or attached to a support material comprising at least one metal, or an oxide, carbide, carbonate, oxycarbonate, halide (such as chloride), oxyhalide (such as oxychloride), or alloy thereof,

wherein one of said at least two components mixed in step (i) is selected from a complex or coordination polymer of said lanthanide and a nitrogen-rich ligand or a salt thereof, or a cluster of said lanthanide; and the other(s) of said at least two components each independently is selected from a nitrogen-rich ligand or a salt thereof, a complex or coordination polymer of said nitrogen-rich ligand of salt thereof with one of said at least one metal, or a cluster of said at least one metal, wherein each one of said at least two components is in the form of a solid, or semi-solid,

provided that when at least one of said components is a complex, coordination polymer, or cluster of a metal other than said lanthanide, the amount, by moles, of said organic or inorganic oxidant, gas generator, pyrotechnic, propellant and/or explosive is higher than the total amount, by moles, of said lanthanide and said at least one metal.

In a particular such aspect, the present invention relates to a process as defined in any one of the embodiments above, i.e., a process for the preparation of particles optionally impregnated within or attached to a support material, each as defined above, wherein at least one of the components mixed in step (i) is in the form of an ionic liquid, e.g., a nitrogen-rich ligand or a salt thereof in the form of an energetic ionic liquid, and the material obtained in step (i) upon mixing said components is an ionic liquid material.

More specifically, the invention relates to a process for the preparation of particles optionally impregnated within or attached to a support material, said particles and said support material, when present, each independently comprising at least one metal or an oxide, carbide, carbonate, oxycarbonate, halide, oxyhalide, or alloy thereof, said process comprising:
(i) mixing at least two components each independently selected from a nitrogen-rich ligand or a salt thereof, a complex or coordination polymer of said nitrogen-rich ligand or salt thereof with one of said at least one metal, or a cluster of said at least one metal, and optionally an organic or inorganic oxidant, gas generator, pyrotechnic, propellant, and/or explosive, wherein each one of said components independently is in the form of a solid, semi-solid, or ionic liquid, provided that at least one of the components is in the form of an ionic liquid, and at least one of said components is a metal complex or coordination polymer of said nitrogen-rich ligand or salt thereof, or a metal cluster, to thereby obtain a homogeneous ionic liquid material; and
(ii) heating or igniting said ionic liquid material at a temperature sufficient to combust said components, but not exceeding 600° C., to thereby obtain said particles, optionally impregnated within or attached to said support material.

In certain embodiments, the process disclosed herein, according to any one of the embodiments defined above, is carried out in a reactor, e.g., a flame reactor, and is a continuous (as opposed to batch) process, making co-deflagration scalable and more economic.

In some particular such embodiments, the process of the present invention is carried out continuously, wherein at least one of the components mixed in step (i) is in the form of an ionic liquid, e.g., a nitrogen-rich ligand or a salt thereof in the form of an energetic ionic liquid, and the material obtained upon mixing said components is an ionic liquid material, which is then fed into said reactor optionally with one or more combustible additives such as alcohols, ethers, esters, aldehydes, ketones, nitriles, nitroalkanes, amines, and amides.

In other particular such embodiments, the process of the present invention is carried out continuously, wherein each one of the components mixed in step (i) independently is in the form of a solid or semi-solid, and the material obtained upon mixing said components is a solid or semi-solid material, which is then fed into said reactor with one or more combustible additives such as alcohols, ethers, esters, aldehydes, ketones, nitriles, nitroalkanes, amines, and amides.

In other particular such embodiments, the process of the present invention is carried out continuously, wherein each one of the components mixed in step (i) independently is in the form of a solid or semi-solid, and the material obtained upon mixing said components is a solid material, which is then grinded in step (ii), and afterwards fed into said reactor using a combustible carrier gas such as methane, butane, propane, a liquefied petroleum gas (liquid petroleum gas), a volatile organic solvent such as methanol, diethyl ether, and trimethylamine, and mixtures thereof.

The processes of the present invention, according to any one of the embodiments above, enable preparing particles of metals, metal alloys, ceramics, ceramic alloys, and supported materials (where one phase is dispersed on and/or within another), referred to herein as metallic products. These metallic products may be used for a variety of uses, e.g., as catalysts.

In certain embodiments, a metallic product prepared as disclosed herein is used as a catalyst in dry or steam reforming of a hydrocarbon, e.g., an alkane such as methane (synthetic fuels and other combustables). The term “alkane” as used herein means a linear or branched hydrocarbon having, e.g., 1-8 carbon atoms and includes methane, ethane, n-propane, isopropane, n-butane, sec-butane, isobutane, tert-butane, n-pentane, isopentane, 2,2-dimethylpropane, n-hexane, n-heptane, n-octane, and the like.

DRM using CO₂ is considered to be a promising technology among several other processes for the reforming of methane (steam reforming, partial oxidation, autothermal reforming, etc.). One of the main interests in this process is due to the consumption of two major greenhouse gases (CO₂ and CH₄) by their conversion to synthesis gas (syngas), which is a mixture of CO and H₂ (Eq. 1). The syngas produced from the DRM process could be further utilized as a starting material for Fischer-Tropsch reaction used for the production of various liquid hydrocarbons and fine chemicals. However, till now, the DRM technology is not heavily industrialized, due to the lack of availability of stable, efficient and economical catalysts.

CH₄+CO₂→2CO+2H₂, ΔH°_{298K}=+247 kJmol⁻¹ (Eq. 1)

In a further aspect, the present invention thus relates to methods for reforming of a hydrocarbon, e.g., an alkane such as methane, carried out in the presence of a catalyst consisting of a metallic product prepared as disclosed herein. In one particular such aspect, disclosed herein is a method for dry reforming of said hydrocarbon, comprising reacting said hydrocarbon with carbon dioxide as the oxidizing agent, in the presence of said catalyst, so as to crack said hydrocarbon into a H₂+CO mixture, which may then be used in a gas-to-liquid conversion for the production of hydrocarbon fuels and other materials. In another particular such aspect, disclosed herein is a method for steam reforming of said hydrocarbon, comprising reacting said hydrocarbon with steam, in the presence of said catalyst, to thereby obtain hydrogen and carbon dioxide. In a further particular such aspect, disclosed herein is a method for mixed dry and steam reforming of said hydrocarbon, comprising reacting said hydrocarbon with both carbon dioxide and steam as the oxidizing agents, in the presence of said catalyst, so as to crack said hydrocarbon into a H₂+CO mixture, which may then be used in a gas-to-liquid conversion for the production of hydrocarbon fuels and other materials. Examples of metallic products for use as catalysts in dry and/or steam reforming of a hydrocarbon such as methane include, without limiting, those consisting of particles of Ni, Ru, Cu, Rh, Re, Co, Fe, or a combination thereof, impregnated within or attached to a support material made of magnesium oxides, calcium oxides, aluminum oxides, cerium oxides, or a combination thereof.

In certain embodiments, a metallic product prepared as disclosed herein is used as a catalyst in carbon monoxide oxidation (automotive and stationary power and other combustables). Examples of metallic products for use as catalysts in such a process include, without being limited to, those consisting of particles of Co, Fe, Ni, Pt, Ru, Rh, or a combination thereof, impregnated within or attached to a support material made of aluminum oxides, magnesium oxides, cerium oxides, or a combination thereof.

In certain embodiments, a metallic product prepared as disclosed herein is used as a catalyst in carbon dioxide hydrogenation (synthetic fuels and other combustables). Examples of metallic products for use as catalysts in such a process include, without being limited to, those consisting of particles of Pt, Pd, Ir, Ru, Re, Cu, Zn, Zr, Ni, Ga, Al, or In, where one of said metals constitutes the support and another one of said metals constitutes the particles dispersed within or attached to the support.

In certain embodiments, a metallic product prepared as disclosed herein is used as a catalyst in hydrocarbon dehydrogenation (synthetic fuels and other combustables). Non-limiting examples of metallic products for use as catalysts in such a process include those consisting of particles of Ni, Ru, Cu, Rh, Re, Co, Fe, or a combination thereof, impregnated within or attached to a support material made of magnesium oxides, calcium oxides, aluminum oxides, cerium oxides, or a combination thereof.

In certain embodiments, a metallic product prepared as disclosed herein is used as a catalyst in NOₓ abatement (automovie and stationary power). Examples of metallic products for use as catalysts in such a process include, without being limited to, those consisting of particles of Ni, Ru, Cu, Rh, Re, Co, Fe, or a combination thereof, impregnated within or attached to a support material made of magnesium oxides, calcium oxides, aluminum oxides, cerium oxides, or a combination thereof.

In certain embodiments, a metallic product prepared as disclosed herein is used as a catalyst in gas-to-liquid (GTL) processing. Examples of metallic products for use as catalysts in such a process include, without limiting, those consisting of particles of Ni, Ru, Cu, Rh, Re, Co, Fe, or a combination thereof, impregnated within or attached to a support material made of magnesium oxides, calcium oxides, aluminum oxides, cerium oxides, or a combination thereof.

In certain embodiments, a metallic product prepared as disclosed herein is used as a catalyst in hydrothermal liquefaction. Examples of metallic products for use as catalysts in such a process include, without being limited to, those consisting of particles of Ni, Ru, Cu, Rh, Re, Co, Fe, or a combination thereof, impregnated within or attached to a support material made of magnesium oxides, calcium oxides, aluminum oxides, cerium oxides, or a combination thereof.

In certain embodiments, a metallic product prepared as disclosed herein is used as a catalyst in water purification. Non-limiting examples of metallic products for use as catalysts in such a process include those consisting of particles of Co, Ni, Mn, Fe, or a combination thereof, impregnated within or attached to a support material made of aluminum oxides, cerium oxides, manganese oxides, magnesium oxides, or a combination thereof.

In certain embodiments, metallic products prepared as disclosed herein are used as piezoelectrics, i.e., materials that can create electricity when subjected to a mechanical stress; thermoelectrics, i.e., materials that can generate electricity from the application of a temperature gradient, or vice versa, through the thermoelectric effect; dielectrics, or dielectric materials, i.e., electrical insulators that can be polarized by an applied electric field; ferroelectrics, i.e., materials having spontaneous electric polarized that can be reversed by the application of an external electric field; pyroelectrics, i.e., polar materials wherein the direction of the polar axis can be changed by the application of an electric field, and are consequently both pyroelectric and piezoelectric; or thermal barrier or other coatings. In further embodiments, such products are used in glass (optics) manufacturing.

In summary, the present invention discloses a new technique for creating ceramic particles (or ceramic alloys thereof), metallic particles (or metallic alloys thereof), or mixed ceramic-metallic particles by the deflagration of multiple nitrogen-rich components, which can be either liquids or solids. Deflagration, as opposed to detonation, is characterized by the subsonic release of gasses during combustion. This technique differs from traditional combustion synthesis techniques, which utilize carbon-rich fuels. The kinetic and thermal energy imparted to the individual metal atoms or ions, upon co-deflagration, drives the formation of particles which can be utilized in applications such as, but not limited to, catalysis, piezoelectrics, thermoelectrics, glass (optics) manufacturing, dielectrics, ferroelectrics, pyroelectrics, and thermal barrier coatings.

In another aspect, the present invention provides a metal-N,N-bis(1H-tetrazole-5-yl)-amine (M-BTA) complex, wherein said metal (M) is Ce, Rh, Ru, Pd, Os, or Ir.

Unless otherwise indicated, all numbers referring, e.g., to amounts of lanthanum oxycarbonate, lanthanum oxide, or lanthanum oxychloride, nickel, and nickel oxide in the supported catalyst disclosed herein, or to temperatures used in the process of the invention, used in the present specification are to be understood as being modified in all instances by the term “about”. Accordingly, unless indicated to the contrary, the numerical parameters set forth in this description and claims are approximations that may vary by up to plus or minus 10% depending upon the desired properties sought to be obtained by the invention.

The invention will now be illustrated by the following non-limiting Examples.

### EXAMPLES

### Experimental

Bis(1H-tetrazole-5-yl)amine [BTA] (U.S. Pat. No. 5,468,866). A solution of boric acid (10.14 g, 164.0 mmol), sodium dicyanamide (7.4 g, 83.1 mmol) and NaN₃ (10.8 g, 166.1 mmol) in water (80 mL) was refluxed for 18 h, while the pH was kept at about 8. The reaction mixture was then cooled to RT and acidified by dropwise addition of concentrated hydrochloric acid to pH 1. Formed white precipitate was collected by filtration, washed with water (until pH 3) and vacuum dried to yield pure BTA as a white powder (5.8 g, 46% yield). FTIR (ATR): 495, 1043, 1554, 1645, 2361, 2853, 2941, 3027, 3453 cm⁻¹. DSC (10° C./min)—endotherms: 120.2 and 138.7° C.; exotherm: 244.2° C.

Ammonium 5,5′-azanediylbis(tetrazol-1-ide) [ammonium-BTA] (U.S. Pat. No. 8,350,050). To a dispersion of BTA (6.0 g, 39.2 mmol) in water (100 mL) ammonia solution (28% in water) was added dropwise at RT until a transparent solution was obtained. The resulted solution was evaporated on a rotovap (at 60° C.) and further vacuum dried to yield pure ammonium-BTA as a white powder (6.7 g, 93% yield). FTIR (ATR): 473, 520, 977, 1631, 2164, 2284, 3157, 3392 cm⁻¹. DSC (10° C./min)—endotherms: 115.5, 132.7° C.; exotherms: 253.1, 278.3, 332.1, 536.2° C.

Ni-BTA complex (U.S. Pat. No. 7,141,675). A solution of ammonium-BTA (3.03 g, 16.2 mmol) and Ni(ClO₄)₂.6H₂O (2.96 g, 8.1 mmol) in water (50 mL) was refluxed for 12 h under vigorous stirring. After that time, the reaction mixture was allowed to cool down to RT, a solvent was evaporated on a rotovap (at 60° C.) and further vacuum dried to yield Ni-BTA complex as a violet powder (5.5 g). FTIR (ATR): 744, 824, 1041, 1303, 1597, 3195 cm⁻¹. DSC (10° C./min)—endotherm: 243.9° C.; exotherms: 366.6, 566.6° C.

Fe-BTA complex (U.S. Pat. No. 7,141,675). A solution of ammonium-BTA (6.07 g, 32.4 mmol) and Fe^{III} (ClO₄)₃.6H₂O (5.2 g, 10.8 mmol) in water (50 mL) was refluxed for 12 h under vigorous stirring. After that time, the reaction mixture was allowed to cool down to RT, a solvent was evaporated on a rotovap (at 60° C.) and resulted solid was further vacuum dried to yield (Fe-BTA) complex as a black powder (5.4 g, 89% yield). FTIR (Nujol): 3557, 3239, 3139, 1610, 1541, 1319, 1253, 1158, 1123, 1073, 1048, 1011, 855, 802, 746, 432 cm⁻¹. DSC (10° C./min)—endotherm: 213° C.

La-BTA complex (WO 2018/229770). A solution of ammonium-BTA (3.03 g, 16.2 mmol) and La(NO₃)₃.6H₂O (3.51 g, 8.1 mmol) in water (50 mL) was refluxed for 12 h under vigorous stirring. After that time, the reaction mixture was allowed to cool down to RT, a solvent was evaporated on a rotovap (at 60° C.) and further vacuum dried to yield La-BTA complex as a white powder (2.3 g). FTIR (ATR): 626, 716, 1424, 1511, 1622, 2320, 3099 cm⁻¹. DSC (10° C./min)—endotherms: 91.1, 149.9° C.; exotherms: 285.7, 328.5° C.

[Mn(N,N-bis(1H-tetrazole-5-yl)-amine)₂][Na(H₂O)]₂ (Mn-BTA). Sodium dicyanamide (0.3 mol, 26.7 g), NaN₃ (0.3 mol, 19.5 g) and Mn(NO₃)₂.4H₂O (0.6 mol, 150.6 g) are dissolved in a mixture of DMF-CH₃CN (2.5:1 v/v) and the pH of this mixture is adjusted to 2, by addition of small amount of HNO₃. Then, the reaction mixture is heated to 180° C. (at a rate of 5° C./min) in a closed reaction vessel. After 72 hours at 180° C., the mixture is slowly cooled to room temperature producing crystals of [Mn(N,N-bis(1H-tetrazole-5-yl)-amine)₂][Na(H₂O)]₂ in 77% yield (based on sodium dicyanamide). IR (KBr): 3277, 3167, 1632, 1514 cm⁻¹. Anal. Calcd. (%) for C₄H₆MnN₁₈Na₂O₂: C, 10.93; H, 1.37; N, 57.38. Found (%): C, 10.72; H, 1.59; N, 57.24.

Ce-BTA complex. To a hot stirred solution (70° C.) of ammonium-BTA (1.6 g, 8.5 mmol) in aqueous ammonia (0.7 M, 10 mL) a solution of CeCl₃7H₂O (1.5 g, 4.0 mmol) in water (20 mL) was added dropwise. At the end of the addition, the reaction mixture was slowly cooled down to room temperature and kept for 6 days to obtain a crystalline Ce-BTA. Resulted white crystals were filtered out and air dried.

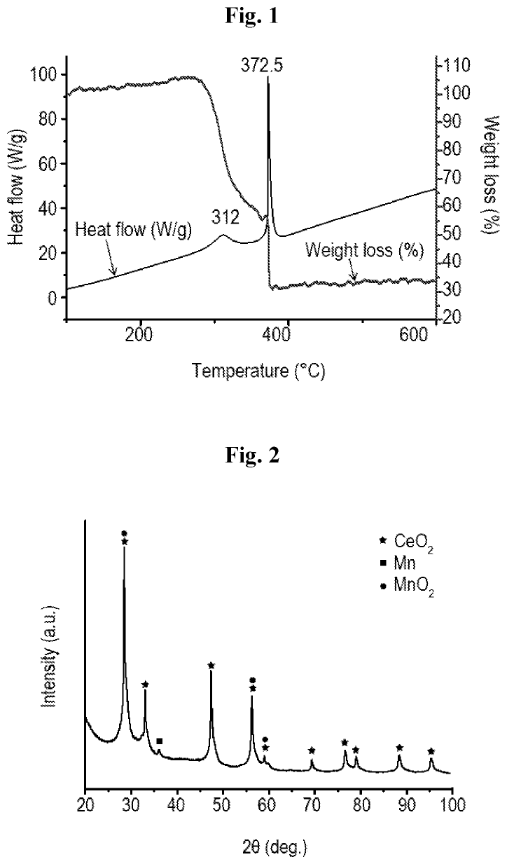

Rh-BTA, Ru-BTA, Pd-BTA, Os-BTA, and Ir-BTA complexes. The process described above for the preparation of the Ce-BTA complex has been applied towards the production of Rh-BTA, Ru-BTA, Pd-BTA, Os-BTA, and Ir-BTA complexes by using soluble precurors of the desired metal in the form of salts or complexes with labile ligands which could be replaced by nitrogen-rich ligands. FIG. 1 shows TGA and DSC of the deflagration of the Pd-BTA complex.

[4-Amino-1-methyl-1,2,4-triazolium][NO₃] (energetic room temperature ionic liquid). To a solution of 4-amino-1-methyl-1,2,4-triazolium iodide (113.0 g, 0.50 mol) in CH₃OH (600 mL) a solution of AgNO₃ (84.9 g, 0.50 mol) in water (400 mL) is added dropwise. After stirring 12 hours at room temperature under light isolation conditions, the AgI precipitate is removed by filtration through Celite. Then, the solvents are evaporated and the liquid is dried under high vacuum at 60° C. for 12 hours, producing [4-amino-1-methyl-1,2,4-triazotium)][NO₃] product as a colorless liquid (75.2 g, 93% yield). DSC: T_{g}=−55° C., T_{dec}=262° C. IR (KBr): 3282, 3141, 3079, 2393, 1750, 1637, 1573, 1537, 1317, 1171, 1071, 979, 881, 828, 658 cm⁻¹. Raman: 3155, 2963, 1574, 1410, 1089, 1074, 1044, 981, 934, 740, 711, 616, 457, 313, 98 cm⁻¹. ¹H NMR (400 MHz, DMSO-d₆): 4.04 (s, 3H, N1-Me), 6.96 (s, 2H, NH2), 9.11 (s, 1H, C3), 10.12 (s, 1H, C5). ¹³C NMR (100 MHz, DMSO-d₆): 39.0, 143.3, 145.3.

[4-Amino-1-methyl-1,2,3,4-triazolium]₃[La(NO₃)₆] (metal-containing energetic room temperature ionic liquid). A mixture of 4-amino-1-methyl-1,2,4-triazolium iodide (0.3 mol, 67.8 g), AgNO₃ (0.3 mol, 51.0 g) and La(NO₃)₃.6H₂O (0.1 mol, 43.3 g) is refluxed in CH₃CN for 1:2 hours under light isolation conditions. After that time, an excess of triethyl orthoformate is added during reflux to remove coordinated water. Subsequently, the reaction mixture is cooled to room temperature, formed AgI is filtered out, and the filtrate is concentrated. The resulting crude liquid is purified by dissolving in CH₃OH (ca. 100 mL), filtering, and adding the filtrate to diethyl ether (3-5 times the volume of filtrate). The mixture is shaken, allowed to separate and the top layer is decanted off. This purification process is repeated to ensure removal of AgI traces. After drying under vacuum [4-amino-1-methyl-1,2,4-triazolium)]₃[La(NO₃)₆] product is obtained as a light-yellow liquid (36 g, 45% yield). DSC: T₅=−24° C., T_{dec}=231° C. IR (KBr): 3332, 3241, 3148, 1632, 1574, 1454, 1325, 1172, 1072, 1038, 981, 877, 819, 735, 615 cm⁻¹. ¹H NMR (CD₃CN): 9.43 (s, 1 H), 8.58 (s, 1 H), 6.13 (br, 2 H), 4.07 (s, 3 H); ¹³C NMR (CD₃CN): 145.9. 144.0, 40.0.

[1,5-Diamino-4-methyl-4-1,2,3,4-tetrazolium]₃[Ce(NO₃)₆]. A mixture of 1,5-diamino-4-methyl-1,2,3,4-tetrazolium iodide (0.3 mol, 72.6 g), AgNO₃ (0.3 mol, 51.0 g) and Ce(NO₃)₃.6H₂O (0.1 mol, 43.4 g) is refluxed in CH₃CN for 12 hours under light isolation conditions. After that time, an excess of triethyl orthoformate is added during reflux to remove coordinated water. Subsequently, the reaction mixture is cooled to room temperature, formed AgI is filtered out, and the filtrate is concentrated. The resulting crude liquid is purified by dissolving in CH₃OH (100 mL), filtering, and adding the filtrate to diethyl ether (3-5 times the volume of filtrate). The mixture is shaken, allowed to separate, and the top layer is decanted off. This purification process is repeated to ensure removal of AgI traces. After drying under vacuum [1,5-diamino-4-methyl-1,2,3,4-tetrazolium]₃[Ce(NO₃)₆] product is obtained as a solid (43 g, 50% yield). DSC: Tₘ=90° C., T_{dec}=187° C. IR: 3339, 3260, 3050, 1700, 1617, 1459, 1350, 1118, 1038, 909, 818, 736, 576 cm⁻¹; ¹H NMR (CD₃CN): 7.61 (s), 6.12. (s, 2. H), 3.96 (s, 3 H). ¹³C NMR (CD₃CN): 149.1, 35.7.

### Example 1

### CeO₂—MnO₂ Ceramic Alloy (Ceramic Alloy)

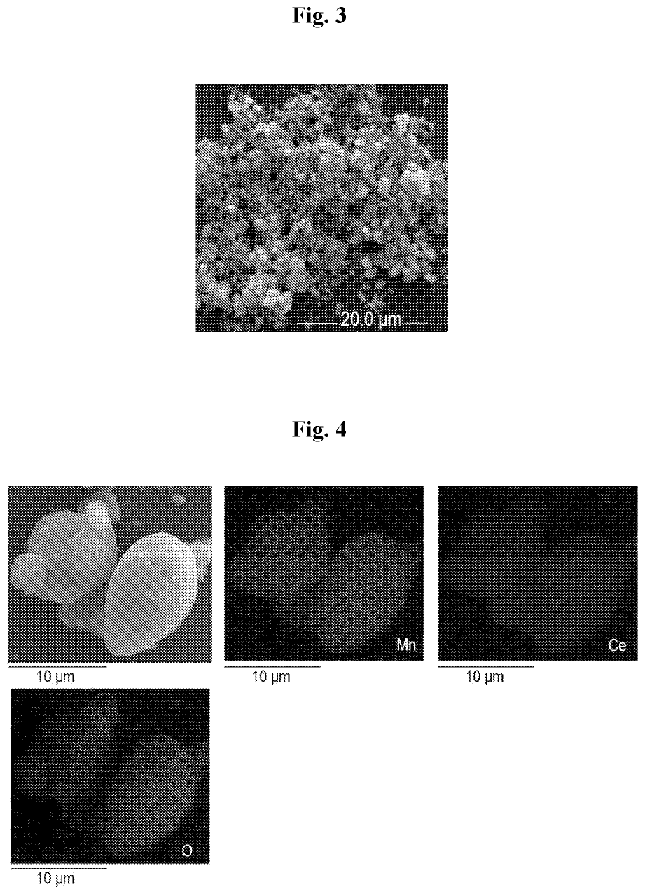

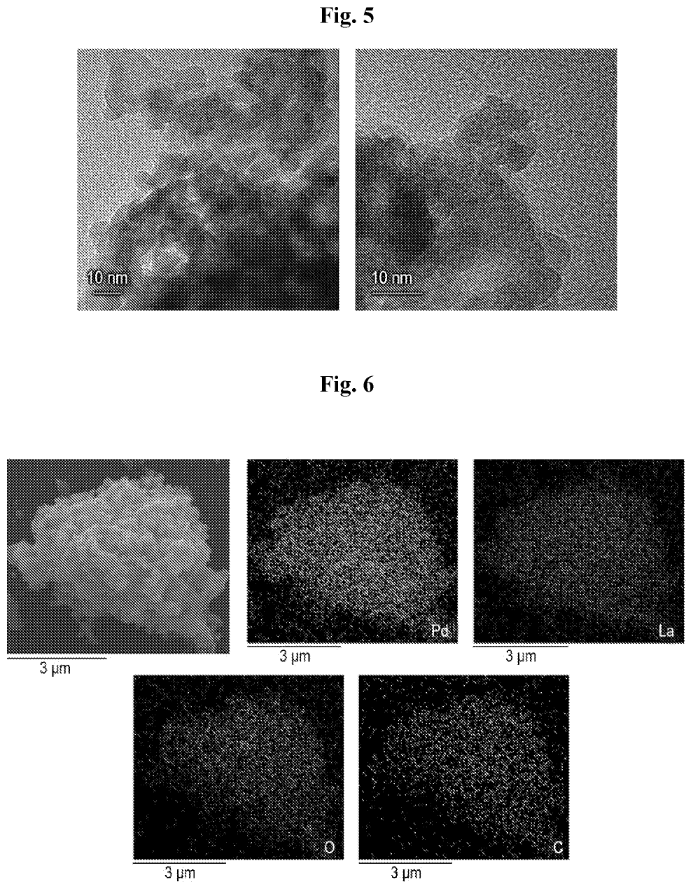

Ce-BTA, Mn-BTA, and ammonium nitrate at a ratio of 1:1:4 were pressed into a pellet using a 100 kN hydraulic press and co-deflagrated in an autoclave, sealed with air at 350° C. The resulting material is an alloy between CeO₂ and MnO₂, with a small amount of metallic Mn particles, dispersed in or above the ceramic alloy. FIGS. 2-5 show XRD pattern of the particles resulting from the co-deflagration of a mixture of Ce-BTA, Mn-BTA and ammonium nitrate (FIG. 2); SEM image of micro-sized particles produced by the co-deflagration of said mixture (FIG. 3); SEM image and elemental mapping showing the even distribution of Mn, Ce, and O throughout the alloy particles produced by the co-deflagration of said mixture (FIG. 4); and TEM images showing that the CeO₂—MnO₂ alloy material generated by the co-deflagration of said mixture has nano-sized domains on the scale of 10 nm (FIG. 5).

### Example 2

### Dispersion of Pd+PdO on and Within La₂O₂CO₃

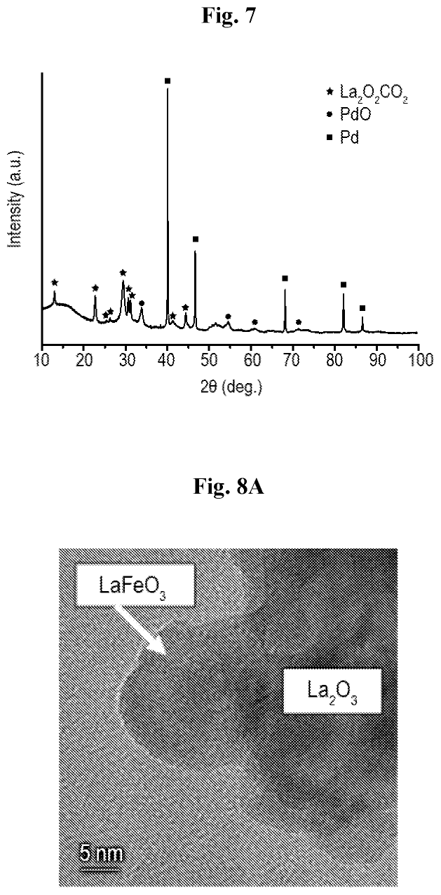

Pd-BTA, prepared as described in Example 1, was mixed with La-BTA and ammonium nitrate, at a ratio of 1:1:4, pressed into a tablet using 100 kN of force, and heated in oxygen to 380° C. until decomposition. The resulting material was Pd+PdO on and within La₂O₂CO₃. FIG. 6 shows SEM image and elemental mapping showing the even distribution of Pd, La, C, and O throughout the alloy particles produced by the co-deflagration of a mixture of Pd-BTA, La-BTA and ammonium nitrate; and FIG. 7 shows XRD pattern of the Pd+PdO supported on or about La₂O₂CO₃.

### Example 3

### Dispersion of LaFeO₃ on and Within a Ceramic Support (Ceramic on Ceramic)

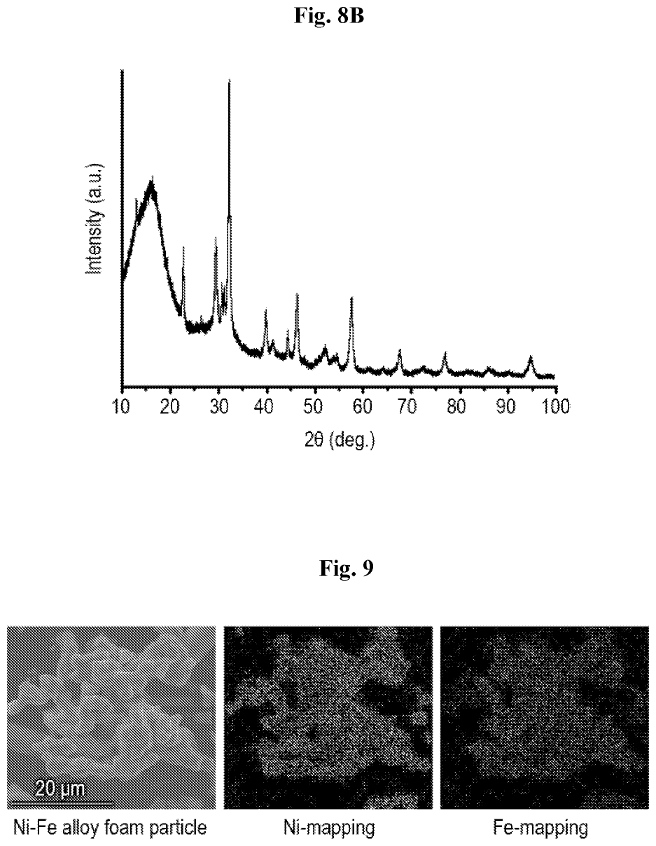

Not only can one make uniform ceramic alloys, but one can also use co-deflagration to achieve a configuration where a nanosized ceramic particle is dispersed about or within a larger ceramic support. For example, La atoms from La-BTA after co-deflagration with Fe-BTA contributed towards forming the large La₂O₃ support as well as LaFeO₃ nanoparticles dispersed on that support. FIGS. 8A-8B show TEM (8A) and accompanying XRD pattern (8B) showing nanosized LaFeO₃ particle on La₂O₃ support via the co-deflagration of La-BTA and Fe-BTA.

### Example 4

### Metallic Ni—Fe Alloy Particles (Metal Alloy)

Ni-BTA was mixed with Fe-BTA and ammonium nitrate, at a ratio of 5:1:4 and heated to 340° C. The co-deflagration the 2 iron-group transition metals (here Ni and Fe) led to the creation of unsupported metal Ni—Fe alloy particles. FIG. 9 shows atomic mapping (energy dispersive x-ray spectroscopy) of Ni—Fe alloy particles in the SEM.

### Example 5

### Metallic Ni Particles (Metal)

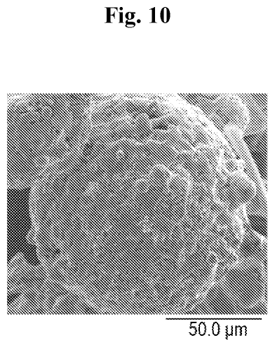

The co-deflagration of Ni-BTA with uncomplexed BTA, in air and at 320° C., led to the formation of porous spherical Ni-metal particles. FIG. 10 shows SEM image of porous spherical Ni particle generated by co-deflagration.

### Example 6

### Preparation of a Liquid Composition Containing Ni and La Metal Precursors that Upon Combustion Produce Ceramic Particles

An ionic liquid mixture containing [4-amino-1-methyl-1,2,4-triazolium]₃[La(NO₃)₆] (33 gram), Ni[N,N-bis(1H-tetrazole-5-yl)-amine]₂ (Ni-BTA) (16 gram), and [4-amino-1-methyl-1,2,4-triazolium][NO₃] (100 gram) is fed into a combustion chamber for co-deflagration. Acetonitrile (50 mL), may be added as an organic solvent to regulate the viscosity of the liquid fed, and air (10 mL/min) is used as both a feeding and oxidizing gas, pushing the liquid mixture into the combustion chamber. The fed mixture has a temperature in the range from about 20° C. to about 150° C., feeding is done at a flow rate from about 0.1 mL/min to about 10 L/min, and the combustion temperature is in a range from about 300° C. to about 1200° C. As a result of the combustion process, mixed ceramic particles containing nickel oxide and lanthanum oxide are formed.

### Example 7

### Preparation of a Liquid Composition Containing Mn and Ce Metal Precursors that Upon Combustion Produce Ceramic Particles

An ionic liquid mixture containing [1,5-diamino-4-methyl-1,2,3,4-tetrazolium]₃[Ce(NO₃)₆] (35 gram), Mn-BTA (19.5 gram), and [4-amino-1-methyl-1,2,4-triazolium][NO₃] (150 gram) is fed into a combustion chamber for co-deflagration. ethylammonium nitrate (50 mL) may be added as an energetic room temperature ionic liquid to regulate the viscosity of the liquid fed, and nitrous oxide (N₂O) (5 mL/min) is used as both a feeding and oxidizing gaseous component, pushing the liquid mixture into the combustion chamber. The fed mixture has a temperature in the range from about 20° C. to about 150° C., feeding is done at a flow rate from about 0.1 mL/min to about 10 L/min, and the combustion temperature is in a range from about 300° C. to about 1200° C. As a result of the combustion process, mixed ceramic particles containing manganese oxide and cerium oxide are formed.

### REFERENCES

1. US 20170354956, High-temperature synthesis of hexaaluminates by flame spraying pyrolysis
2. WO 2014027308, Ceria-zirconia-mixed oxide particles and process for their production by pyrolysis
3. Zhenhua Li; Lijuan Zhang; Kechao Zhao; Li Bian, Ni/ZrO₂ catalysts synthesized via urea combustion method for CO₂ methanation, Transactions of Tianjin University, 2018, 24, 471-479
4. Massimiliano Massi; Stefano Stagni; Mark I. Ogden, Lanthanoid tetrazole coordination complexes, Coordination Chem. Reviews, 2018, 375, 164-172
5. Jiao-Min Lin; Yang-Fan Guan; Dong-Yao Wang; Wen Dong; Xiu-Teng Wang; Song Gao, Syntheses, structures and properties of seven isomorphous 1D Ln³⁺ complexes Ln(BTA)(HCOO)(H₂O)₃ (H₂BTA=bis(tetrazoly)amine, Ln=Pr, Gd, Eu, Tb, Dy, Er, Yb) and two 3D Ln³⁺ complexes Ln(HCOO)₃ (Ln=Pr, Nd), Dalton Trans., 2008, 6165-6169
6. Georg Steinhauser; Gerald Giester; Nicolae Leopold; Christoph Wagner; Mario Villa; Andreas Musilek, Nitrogen-rich compounds of the lanthanoids: highlights and summary, Helvetica Chimica Acta 2010, 93, 183-202
7. Danny Müller, Christian Knoll, Andrea Herrmann, Gokcen Savasci, Jan M. Welch, Werner Artner, Johannes Ofner; Bernhard Lendl; Gerald Giester; Peter Weinberger; Georg Steinhauser, Azobis[tetrazolide]-carbonates of the lanthanides—Breaking the gadolinium break, Eur. J. Inorg. Chem., 2018, 19, 1969-1975

### Synthesis of Energetic Precursors Mn(BTA)ₙ

1. Friedman, Yoel; Goldberg, Israel, Tetrazole-bridged manganese coordination polymer as high-energy material, Polyhedron, 2018, 139, 327-330
2. Lin, Jiao-Min; Huang, Bei-Shu; Guan, Yang-Fan; Liu, Zhao-Qing; Wang, Dong-Yao; Dong, Wen, Syntheses, structures and properties of seven H₂BTA coordinating 3-D metallic complexes containing 0-, 1-, 2-, and 3-D frameworks (H₂BTA=bis (tetrazolyl) amine), CrystEngComm (2009), 11(2), 329-336
3. Lu, Ying-Bing; Wang, Ming-Sheng; Zhou, Wei-Wei; Xu, Gang; Guo, Guo-Cong; Huang, Jin-Shun, Novel 3-D PtS-like tetrazolate-bridged manganese(II) complex exhibiting spin-canted antiferromagnetism and field-induced spin-flop transition, Inorganic Chemistry, 2008, 47(19), 8935-8942
4. Liu, Na; Yue, Qi; Wang, Yan-Qin; Cheng, Ai-Ling; Gao, En-Qing, Coordination compounds of bis(5-tetrazolyl)amine with manganese(II), zinc(II) and cadmium(II): synthesis, structure and magnetic properties, Dalton Transactions, 2008, (34), 4621-4629
5. Lin, Jiao-Min; Guan, Yang-Fan; Dong, Wen, Diaquabis[5-(1H-tetrazol-5-ylamino-κN4)tetrazolato-κN1]manganese(II) dihydrate, Acta Crystallographica, Section E: Structure Reports Online, 2007, 63(12), m3017
6. Gao, En-Qing; Liu, Na; Cheng, Ai-Ling; Gao, Song, Novel frustrated magnetic lattice based on triangular [Mn3(μ3-F)] clusters with tetrazole ligands, Chemical Communications, 2007, (24), 2470-2472
   Ni(5-aminotetrazole)ₙ [Ni(5AT)]
1. EP 2450329, Priming charge containing a tetrazole compound
2. Gabryszewski, M, The 5-aminotetrazole complexes of Co(II), Ni(II) and Cu(II) in aqueous solution, Polish Journal of Chemistry, 1993, 67(11), 2081-2084
   Mn(5-aminotetrazole)ₙ [Mn(5AT)]
1. Buvaylo, Elena A.; Kokozay, Vladimir N.; Vassilyeva, Olga Yu.; Skelton, Brian W.; Degtyarik, Mikhail M.; Korabik, Maria; Jezierska, Julia, Synthesis, structure, and characterizations of a new antiferromagnetic manganese(II) dichloro-bridged 1-D polymer decorated by 5-amino-1-H-tetrazole, Journal of Coordination Chemistry, 2015, 68(7), 1261-1272
2. Liu, Zhong-Yi; Zou, Hong-Ai; Hou, Zhao-Jun; Yang, En-Cui; Zhao, Xiao-Jun, Structural motif-dependent magnetic diversity observed in three-dimensional tetrazolyl-based MMOFs: synthesis, structures and magnetism, Dalton Transactions, 2013, 42(44), 15716-15725
3. Wang, Tian-Wei; Liu, Dong-Sheng; Huang, Chang-Cang; Sui, Yan; Huang, Xi-He; Chen, Jian-Zhong; You, Xiao-Zeng, Syntheses, crystal structures, and magnetic properties of two Mn(II) coordination polymers based on the 5-aminotetrazole ligand: effect of sources of ligand on construction of topological networks, Crystal Growth & Design, 2010, 10(8), 3429-3435
   Fe(5-aminotetrazole)ₙ [Fe(5AT)]
1. Pimenta, Vanessa; Le, Quang Hoang Hanh; Clark, Lucy; Lhoste, Jerome; Hemon-Ribaud, Annie; Leblanc, Marc; Greneche, Jean-Marc; Dujardin, Gilles; Lightfoot, Philip; Maisonneuve, Vincent, New iron tetrazolate frameworks: synthesis, temperature effect, thermal behaviour, Mossbauer and magnetic studies, Dalton Transactions, 2015, 44(17), 7951-7959
2. WO 2008127107, A pyrotechnic colour composition
3. US 20060011276, Electrically controlled solid propellant
4. WO 9825868, Solid solution vehicle airbag clean gas generator propellant

### Ni(bistetrazole)ₙ [Ni(BT)]

1. US 20060054257, Gas-generant material
2. U.S. Pat. No. 6,689,237, Gas-generants containing a transition metal complex of ethylenediamine 5,5′-bitetrazole

### Mn(bistetrazole)ₙ [Mn(BT)]

1. Chesnokov, Gleb A.; Topchiy, Maxim A.; Asachenko, Andrey F.; Muravyev, Nikita V.; Grishin, Leonid I.; Nikiforova, Anna S.; Utochnikova, Valentina V.; Rybakov, Victor B.; Khrustalev, Victor N.; Nechaev, Mikhail S, Rare-earth complexes with the 5,5′-bitetrazolate ligand—synthesis, structure, luminescence properties, and combustion catalysis, European Journal of Inorganic Chemistry, 2018, 2018(6), 805-815
2. Pohl, Roland W. H.; Wiebke, Jonas; Klein, Axel; Dolg, Michael; Maggiarosa, Nicola, A new 5,5′-bitetrazole thorium(IV) compound: synthesis, crystal structure and quantum chemical investigation, European Journal of Inorganic Chemistry, 2009, (17), 2472-2476
3. Eulgem, Patrick J.; Klein, Axel; Maggiarosa, Nicola; Naumann, Dieter; Pohl, Roland W. H., New rare earth metal complexes with nitrogen-rich ligands: 5,5′-bitetrazolate and 1,3-bis(tetrazol-5-yl)triazenate—on the borderline between coordination and the formation of salt-like compounds, Chem. European Journal, 2008, 14(12), 3727-3736
4. Chai, Yu-ping; Zhang, Tong-lai; Yao, Jun; Guti Huojian Jishu, Synthesis and characterization of bitetrazole salts, 2007, 30(3), 248-252
5. U.S. Pat. No. 6,214,139, Low-smoke pyrotechnic compositions
6. Hiskey, Michael A.; Chavez, David E.; Naud, Darren L.; Son, S. Forrest; Berghout, H. Laine; Bolme, Cynthia A., Progress in high-nitrogen chemistry in explosives, propellants and pyrotechnics, Proceedings of the International Pyrotechnics Seminar, 2000, 27^{th}, 3-14
7. U.S. Pat. No. 6,077,371, Gas generants comprising transition metal nitrite complexes
8. WO 9839275, Gas generants comprising carbonato metal amine complexes
9. WO 9839274, Gas-generants complex oxidizers with multimetal cations
10. WO 9837040, Gas generator propellant compositions
11. Matsuzawa, Toshio; Itoh, Mamoru; Arai, Mitsuru; Tamura, Masamitsu, Evaluation of sensitivities for tetrazole-oxidizer compositions, Proceedings of the International Pyrotechnics Seminar, 1996, 22^{nd}, 317-324
12. JP07033754 A, Preparation of 5,5′-bi-1H-tetrazole salt
13. DE 4412871, Compositions for gas generators
14. JP 06080492, Gas-generating compositions for inflation of automobile airbags

### Fe(bistetrazole)ₙ [Fe(BT)]

1. US 20060054257, Gas-generant materials
2. U.S. Pat. No. 6,689,237, Gas-generants containing a transition metal complex of ethylenediamine 5,5′-bitetrazole
   La(bistetrazole)ₙ [La(BT)] and Ce(bistetrazole)ₙ [Ce(BT)]
1. Chesnokov, Gleb A.; Topchiy, Maxim A.; Asachenko, Andrey F.; Muravyev, Nikita V.; Grishin, Leonid I.; Nikiforova, Anna S.; Utochnikova, Valentina V.; Rybakov, Victor B.; Khrustalev, Victor N.; Nechaev, Mikhail S, Rare-earth complexes with the 5,5′-bitetrazolate ligand—synthesis, structure, luminescence properties, and combustion catalysis, European Journal of Inorganic Chemistry, 2018, 2018(6), 805-815
2. Eulgem, Patrick J.; Klein, Axel; Maggiarosa, Nicola; Naumann, Dieter; Pohl, Roland W. H., New rare earth metal complexes with nitrogen-rich ligands: 5,5′-bitetrazolate and 1,3-bis(tetrazol-5-yl)triazenate—on the borderline between coordination and the formation of salt-like compounds, Chem. European Journal, 2008, 14(12), 3727-3736

### Pd(BTA)₂ Complex

1. Luther, E.; Tappan, B.; Mueller, A.; Mihaila, B.; Volz, H.; Papin, P.; Veauthier, J.; Cardenas, A.; Stan, M., Nanostructured metal foams: synthesis and applications, Advances in Powder Metallurgy & Particulate Materials, 2009, 9/129-9/139

### Ionic Liquids

1. Zhang, Q; Shreeve, J M, Energetic ionic liquids as explosives and propellant fuels: a new journey of ionic liquid chemistry. Chem. Rev., 2014, 114(20), 10527-10574
2. Sebastiao, E; Cook, C; Hu, A; Murugesu, M, Recent developments in the field of energetic ionic liquids. J. Mater. Chem. A, 2014, 22, 8153-8173
3. Drake, G; Kaplan, G; Hall, L; Hawkins, T; Larue, J, A new family of energetic ionic liquids 1-amino-3-alkyl-1,2,3-triazolium nitrates. J. Chem. Crystallogr. 2007, 37, 1, 15-23
4. Prodius, D; Mudring, A V. Rare earth metal-containing ionic liquids. Coord. Chem. Rev. 2018, 363, 1-16
5. Ji, S P; Tang, M; He, L; Tao, G H, Water free rare-earth-metal ionic liquids/ionic liquid crystals based on hexanitratolanthanate(III) anion. Chem. Eur. J. 2013, 19, 4452-4461
6. Tao, G H; Huang, Y; Boatz, J A; Shreeve, J M. Energetic ionic liquids based on lanthanide nitrate complex anions. Chem Eur. J. 2008, 14, 11167-11173
7. Binnemans, K. Lanthanides and actinides in ionic liquids. Chem. Rev. 2007, 107(6), 2592-2614

1. A process for the preparation of particles optionally impregnated within or attached to a support material, said particles and said support material, when present, each independently comprising at least one metal or an oxide, carbide, carbonate, oxycarbonate, halide, oxyhalide, or alloy thereof, said process comprising:
(i) mixing at least two components each independently selected from the group consisting of a nitrogen-rich ligand or a salt thereof, a complex or coordination polymer of said nitrogen-rich ligand or salt thereof with one of said at least one metal, and a cluster of said at least one metal, and optionally an organic or inorganic oxidant, gas generator, pyrotechnic, propellant, and/or explosive, wherein each one of said at least two components independently is in the form of a solid, semi-solid, or ionic liquid, provided that at least one of the components is in the form of an ionic liquid, and at least one of said components is a metal complex or coordination polymer of said nitrogen-rich ligand or salt thereof, or a metal cluster, to thereby obtain a homogeneous solid, semi-solid, or ionic liquid material;
(ii) optionally grinding said homogeneous solid material;
(iii) optionally pressing said homogeneous solid or semi-solid material into a form (pellet); and
(iv) heating or igniting said ionic liquid material or optionally pressed homogeneous solid or semi-solid material, at a temperature sufficient to combust said at least two components, but not exceeding 600° C., to thereby obtain said particles, optionally impregnated within or attached to said support material.

2. The process of claim 1, further comprising:
(i) subjecting the particles obtained in said (iv) to a temperature sufficient to oxidize residual organic matter, but not exceeding 1200° C., in the flow of a mixture comprising O₂, O₃, a nitrogen oxide, an organic peroxide, or hydrogen peroxide, and an inert gas selected from the group consisting of Ar, He and N₂; and/or
(ii) subjecting the product obtained in said (v) to a temperature sufficient to reduce the oxide of said metal or metal alloy obtained, but not exceeding 1200° C., in the flow of a mixture comprising an inert gas selected from the group consisting of Ar, He and N₂, and a reducing gas such as H₂ or NH₃.

3. The process of claim 1, wherein at least one of said components mixed in said (i) is a metal complex of said nitrogen-rich ligand or a salt thereof, and said metal complex is in the form of a metal organic framework, or a coordination polymer.

4. The process of claim 1, wherein said at least one metal each independently is Li, Na, K, Rb, Cs, Be, Mg, Ca, Sr, Ba, Sc, Y, La, Ce, Pr, Nd, Pm, Sm, Eu, Gd, Tb, Dy, Ho, Er, Tm, Yb, Lu, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Al, Ga, In, Si, Ge, Sn, Pb, Sb, Bi, Se, or Te.

5. The process of claim 4, wherein said at least one metal each independently is La, Ce, Mn, Fe, Ni, Rh, Ru, Pd, Os, or Ir.

6. The process of claim 5, wherein (i) one of said at least one metal is Ce and the other one of said at least one metal is Mn: (ii) one of said at least one metal is Pd and the other one of said at least one metal is La; (iii) one of said at least one metal is La and the other one of said at least one metal is Fe; or (iv) one of said at least one metal is Ni and the other one of said at least one metal is Fe; or (v) said at least one metal is Ni.

7. The process of claim 1, wherein said nitrogen-rich ligand or salt thereof each independently is selected from the group consisting of ammonia, amides, hydroxylamine, nitroso, nitrate, nitrite, azide, hydrazine, imidazoles, aminoimidazoles, hydrazoimidazoles, nitroimidazoles, azidoimidazoles, triazoles, aminotriazoles, hydrazotriazoles, cyanotriazoles, nitrotriazoles, azidotriazoles, tetrazoles, N,N-bis(1H-tetrazole-5-yl)-amine (BTA), aminotetrazoles, hydrazotetrazoles, cyanotetrazoles, nitrotetrazoles, azidotetrazines, pentazoles, triazines, aminotriazines, melamine, 2,4,6-trihydrazineyl-1,3,5-triazine, hydrazotriazines, cyanotriazines, nitrotriazines, tetrazines, aminotetrazines, 3,6-diamino-1,2,4,5-tetrazine-1,4-dioxide, hydrazotetrazines, cyanotetrazines, ureas, hydrazinecarboxamides, nitroureas, cyanoureas, oxalohydrazides, 2-amino-2-iminoacetamide, oxalimidamide, 2-hydrazineyl-2-imino-acetohydrazide, oxalimidohydrazide, guanidines, guanylureas, aminoguanidines, cyanoguanidines, nitroguanidines, dinitromethanes, trinitromethanes, N-nitro-nitramide, N-nitrocyanamide, N-dicyanamide, a mixture of ammonium nitrate with hydrazine (Astrolite G), hydrazinium nitrate, hydroxylammonium nitrate, and an energetic ionic liquid selected from the group consisting of 1-amino-3-alkyl-1,2,3-triazolium nitrate, 4-amino-1-alkyl-1,2,4-triazolium nitrate, and 1-alkyl-3-alkyl-imidazolium nitrate.

8. The process of claim 7, wherein said nitrogen-rich ligand or salt thereof each independently is triazole, tetrazole, BTA, 5,5-diazotetrazolate triazole, tetrazine, melamine, a nitramine, a guanidine, a guanylurea, a nitroguanidine, a nitrourea, an aminoguanidine, or an energetic ionic liquid selected from the group consisting of 1-amino-3-alkyl-1,2,3-triazolium nitrate, 4-amino-1-alkyl-1,2,4-triazolium nitrate, and 1-alkyl-3-alkyl-imidazolium nitrate.

9. The process of claim 8, wherein said nitrogen-rich ligand or salt thereof each independently is BTA, or an energetic ionic liquid selected from the group consisting of 1-amino-3-ethyl-1,2,3-triazolium nitrate, 1-amino-3-propyl-1,2,3-triazolium nitrate, 1-amino-3-(2-propenyl)-1,2,3-triazolium nitrate, 4-amino-1-methyl-1,2,4-triazolium nitrate, 4-amino-1-ethyl-1,2,4-triazolium nitrate, 4-amino-1-butyl-1,2,4-triazolium nitrate, 1-butyl-3-methyl-imidazolium nitrate, 1-isobutyl-3-methyl-imidazolium nitrate, and 1-dodecyl-3-methyl-imidazolium nitrate.

10. The process of claim 1, wherein at least one of said at least two components independently is:
(a) a complex of BTA with a metal selected from the group consisting of La, Ce, Mn, Fe, Ni, Rh, Ru, Pd, Os, and Ir;
(b) an energetic ionic liquid selected from the group consisting of 1-amino-3-ethyl-1,2,3-triazolium nitrate, 1-amino-3-propyl-1,2,3-triazolium nitrate, 1-amino-3-(2-propenyl)-1,2,3-triazolium nitrate, 4-amino-1-methyl-1,2,4-triazolium nitrate, 4-amino-1-ethyl-1,2,4-triazolium nitrate, 4-amino-1-butyl-1,2,4-triazolium nitrate, 1-butyl-3-methyl-imidazolium nitrate, 1-isobutyl-3-methyl-imidazolium nitrate, and 1-dodecyl-3-methyl-imidazolium nitrate; or
(c) a lanthanate-containing energetic ionic liquid selected from the group consisting of [1-amino-3-ethyl-1,2,3-triazolium]₃[La(NO₃)₆], [1-amino-3-propyl-1,2,3-triazolium]₃[La(NO₃)₆], [1-amino-3-(2-propenyl)-1,2,3-triazolium]₃[La(NO₃)₆], [4-amino-1-methyl-1,2,4-triazolium]₃[La(NO₃)₆], [4-amino-1-ethyl-1,2,4-triazolium]₃[La(NO₃)₆], [4-amino-1-butyl-1,2,4-triazolium]₃[La(NO₃)₆], [1-butyl-3-methyl-imidazolium]₃[La(NO₃)₆], [1-isobutyl-3-methyl-imidazolium]₃[La(NO₃)₆], and [1-dodecyl-3-methyl-imidazolium]₃[La(NO₃)₆].

11. The process of claim 1, wherein said inorganic oxidant is ammonium nitrate, ammonium dinitramide, or ammonium perchlorate; or said organic oxidant is a peroxide, trinitromethane salt, 2,2,2-trinitroethanol or a derivative thereof, 2,2-dinitromethane or a salt or derivative thereof, or 2,2-dinitroethanol or a salt or derivative thereof.

12. The process of claim 1, wherein said ionic liquid material or optionally pressed homogeneous solid or semi-solid material is heated or ignited in said (iv) together with one or more combustible additives such as alcohols, ethers, esters, aldehydes, ketones, nitriles, nitroalkanes, amines, and amides.

13. The process of claim 1, wherein said particles optionally impregnated within or attached to said support material, obtained in said (iv), are metal particles, metal alloy particles, ceramic particles, ceramic alloy particles, or a combination thereof; and said support material, when present, is made of a ceramic, ceramic alloy, or a combination thereof.

14. The process of claim 1, wherein:
(a) the components mixed in said (i) are Ce-BTA complex and Mn-BTA complex, said inorganic oxidant is ammonium nitrate, the molar ratio between said Ce-BTA complex, said Mn-BTA complex and said ammonium nitrate is about 1:1:4, respectively, said temperature is about 350° C., and the particles obtained in said (iv) are metallic Mn particles impregnated within or attached to a ceramic alloy support material made of CeO₂ and MnO₂;
(b) the components mixed in said (i) are Ni-BTA complex and Fe-BTA complex, said inorganic oxidant is ammonium nitrate, the molar ratio between said Ni-BTA complex, said Fe-BTA complex and said ammonium nitrate is about 5:1:4, respectively, said temperature is about 340° C., and the particles obtained in said (iv) are unsupported metal alloy Ni—Fe particles;
(c) the components mixed in said (i) are Ni-BTA complex and BTA, said temperature is about 320° C., and the particles obtained in said (iv) are metallic Ni particles;
(d) the components mixed in said (i) are [4-amino-1-methyl-1,2,4-triazolium]₃[La(NO₃)₆], Ni-BTA complex and [4-amino-1-methyl-1,2,4-triazolium][NO₃], at a weight ratio of about 33:16:100, respectively, forming an ionic liquid mixture; acetonitrile is optionally added to regulate the viscosity of said ionic liquid; air is optionally added as an oxidizing gas; the ionic liquid mixture is combusted at a temperature in a range from about 300° C. to about 1200° C.; and the particles obtained in said (iv) are unsupported ceramic particles containing nickel oxide and lanthanum oxide; or
(e) the components mixed in said (i) are [1,5-diamino-4-methyl-1,2,3,4-tetrazolium]₃[Ce(NO₃)₆], Mn-BTA complex and [4-amino-1-methyl-1,2,4-triazolium][NO₃], at a weight ratio of about 35:19.5:150, respectively, forming an ionic liquid mixture; ethylammonium nitrate is optionally added to regulate the viscosity of said ionic liquid; nitrous oxide is optionally added as an oxidizing gas; the ionic liquid mixture is combusted at a temperature in a range from about 300° C. to about 1200° C.; and the particles obtained in said (iv) are unsupported ceramic particles containing manganese oxide and cerium oxide.

15. The process of claim 1, wherein said particles are millimeter-sized particles, microparticles, or nanoparticles.

16. The process of claim 1, for preparation of (i) a ceramic particles impregnated within or attached to a ceramic as the support material; (ii) a ceramic particles impregnated within or attached to a ceramic alloy as the support material; (iii) a ceramic alloy particles; (iv) a metal or metal alloy particles supported on a ceramic as the support material; (v) a metal or metal alloy particles supported on a ceramic alloy as the support material; (vi) a cermet particles; or (vii) a metal or metal alloy particles.

17. (canceled)

18. The process of claim 1, wherein the material obtained in said (i) upon mixing said at least two components is an ionic liquid material.

19. The process of claim 1, wherein said process is carried out in a reactor, such as a flame reactor, continuously.

20. The process of claim 19, wherein:
(i) the material obtained in said (i) upon mixing said at least two components is an ionic liquid material, and said ionic liquid material is fed into said reactor optionally with one or more combustible additives such as alcohols, ethers, esters, aldehydes, ketones, nitriles, nitroalkanes, amines, and amides;
(ii) the material obtained in said (i) upon mixing said at least two components is a solid or semi-solid material, and said solid or semi-solid material is fed into said reactor with one or more combustible additives such as alcohols, ethers, esters, aldehydes, ketones, nitriles, nitroalkanes, amines, and amides; or
(iii) the material obtained in said (i) upon mixing said at least two components is a solid material, which is then grinded in said (ii), and said grinded solid material is fed into said reactor using a combustible carrier gas such as methane, butane, propane, a liquefied petroleum gas, a volatile organic solvent, and mixtures thereof.

21-23. (canceled)
